(19) United States
(12) Patent Application Publication
(10) Pub. No.: US 2004/0177129 A1
(43) Pub. Date: Sep. 9, 2004

(54) Method and apparatus for distributing logical units in a grid

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, New York

(21) Appl. No.: 10/383,849

(22) Filed: Mar. 6, 2003

(51) Int. Cl. G06F 15/16

(52) U.S. Cl. 709/219

(57) ABSTRACT

A method, apparatus, and computer instructions for obtaining a logical unit. A request is sent for the logical unit. In the depicted examples, the request is sent to a multicast IP address. Responses to the request for the logical unit are received from a number of responders. A responder is identified from the set of responders to form a selected responder. The selected responder is identified based on at least one connection metric between the data processing system and the set of responders. The logical unit is retrieved from the selected responder.

### BACKGROUND OF THE INVENTION

1. Technical Field

The present invention relates generally to an improved data processing system and in particular to an improved method and apparatus for obtaining data. Still more particularly, the present invention provides a method and apparatus and computer instructions for transferring units of data between different nodes in a grid.

2. Description of Related Art

Network data processing systems are commonly used in all aspects of business and research. These networks are used for communicating data and ideas as well as providing a repository to store information. Further, in many cases the different nodes making up a network data processing system may be employed to process information. Individual nodes may have different tasks to perform. Additionally, it is becoming more common to have the different nodes work towards solving a common problem, such as a complex calculation. A set of nodes participating in a resource sharing scheme is also referred to as a “grid ” or “grid network ”. For example, nodes in a grid network may share processing resources to perform a complex computation, such as deciphering keys.

The nodes in a grid network may be contained within a network data processing system, such as a local area network (LAN) or a wide area network (WAN). These nodes also may be located in different geographically diverse locations. For example, different computers connected to the Internet may provide processing resources to a grid network. By applying the use of thousands of individual computers, large problems can be solved quickly. Grids are used in many areas, such as cancer research, physics, and geosciences.

Currently, computing and file sharing occurs from a central data base in a file replica scheme. Grids often deal with large amounts of data, which is collected in a central location, called a replica server. Files can be grouped into a logical unit, which is a simple set of files. Logical units are a well-defined set of files and are defined by the replica server for all clients. Applications, in general, do not need access to the entire database that is located at the central location. Instead, applications often can run to completion by referencing only a logical unit.

Therefore, before a grid application executes on a given grid node, this application will request any necessary logical unit or units from the replica server. These files are replicated onto the grid node containing the application. Thereafter, the application executes using these files. In the current model, data is replicated, forming input data. Any results or changes to the data in these files are written back to the replica server external to the replica services. In other words, the applications provide their own locking for data.

One problem with this scheme is that grids are often geographically diverse, and the replica server may distribute the same logical unit to two or more nodes on the same network. Nodes are required to obtain the logical unit from the replica server. The present invention recognizes that distances between the replica nodes and the server, as well as multiple requests for the logical unit may result in bottle necks at the replica server as a result of increased traffic.

Therefore, it would be advantageous to have an improved method, apparatus, and computer instructions for distributing logical units in a network data processing system.

### SUMMARY OF THE INVENTION

The present invention provides a method, apparatus, and computer instructions for obtaining a logical unit. A request is sent for the logical unit. In the depicted examples, the request is sent to a multicast IP address. Responses to the request for the logical unit are received from a number of responders. A responder is identified from the set of responders to form a selected responder. The selected responder is identified based on at least one connection metric between the data processing system and the set of responders. The logical unit is retrieved from the selected responder.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in distributing logical units in a network data processing system in accordance with a preferred embodiment of the present invention;

FIG. 5 is a flowchart of a process for requesting a logical unit in accordance with a preferred embodiment of the present invention; and

FIG. 6 is a flowchart of a process for responding to a request for a logical unit in accordance with a preferred embodiment of the present invention.

### DETAILED DESCRIPTION OF THE PREFERRED EMBODIMENT

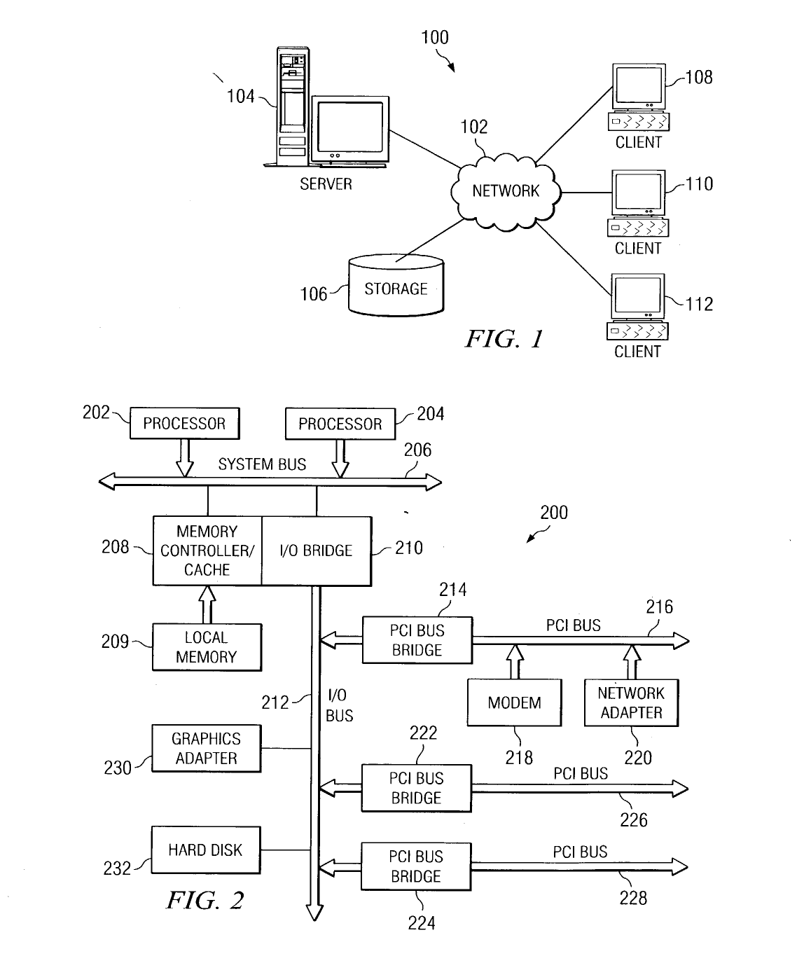

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention. The different servers and clients within network data processing system 100 are also referred to as nodes.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

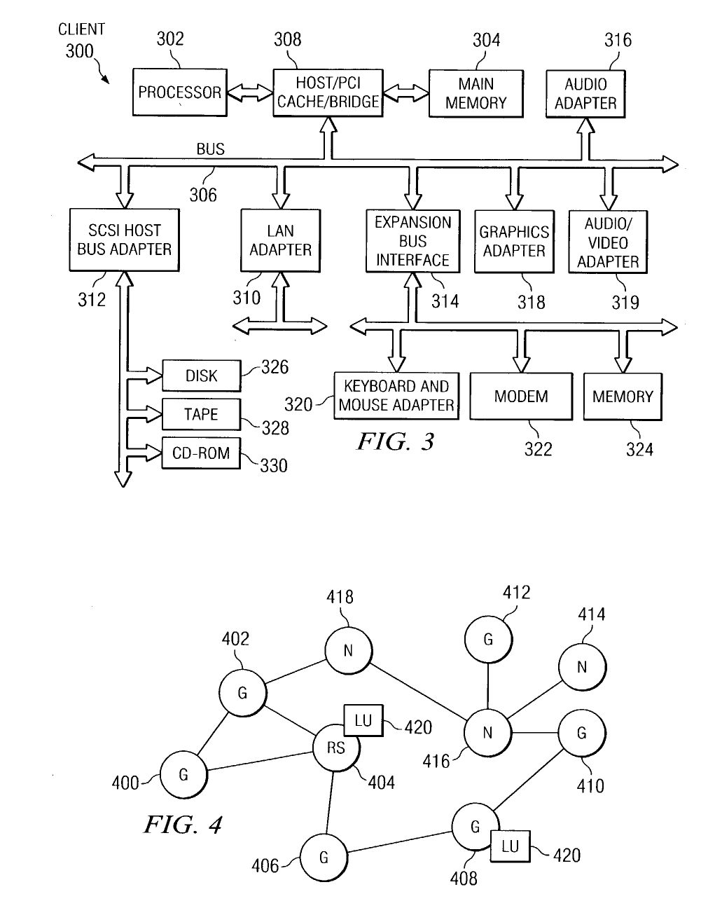

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java ” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG 3. Also, the processes of the present invention may be applied to a multiprocessor data processing system.

The depicted example in FIG. 3 and above-described examples are not meant to imply architectural limitations. As a further example, data processing system 300 may be a personal digital assistant (PDA) device or a notebook computer.

The present invention recognizes that one characteristic of a grid is that different nodes within the grid may be in geographically diverse locations. The nodes may be scattered throughout the Internet. The present invention also recognizes that nodes other than the replica server may already contain a logical unit. In such a case, a neighboring node may serve or send the requested logical unit to the grid node requiring the logical unit in accordance with a preferred embodiment of the present invention.

Thus, the present invention provides a method, apparatus, and computer instructions for distributing logical units in a network data processing system such as a grid. This mechanism distributes logical units throughout a geographically diverse network without requiring a reconfiguration of the replica server pool. Client nodes request a logical unit using a multicast Internet protocol (IP) address instead of a replica server multicast IP address. With this mechanism, the replica server will always respond to this IP address. Additionally, clients containing the requested logical unit may also respond to this multicast IP address.

With reference now to FIG. 4, a diagram illustrating components used in distributing logical units in a network data processing system is depicted in accordance with a preferred embodiment of the present invention. In this example, nodes, 400, 402, 404, 406, 408, 410, and 412 are nodes in a grid. Nodes 414, 416, and 418 are nodes that are not part of the grid. These nodes may be located in a network data processing system such as network data processing system 100 in FIG. 1. In this example, these nodes are all nodes that are part of the Internet.

In this example, node 404 may serve as a replica server for logical units. In this example, node 400 may be implemented using a server, such as data processing system 200 in FIG. 2. Other nodes may be implemented using a data processing system, such as data processing system 300 in FIG. 3. In response to requests from other nodes within the grid, node 404 will serve or send the appropriate logical units to the requesting nodes. Additionally, the present invention provides a mechanism in which other nodes that contain logical units may respond to requests.

For example, node 408 contains logical unit 420. This logical unit also is found in node 404 which serves as a replica server. Node 410 generates a request for a logical unit such as logical unit 420. This request is sent over a multicast IP address, which is monitored by node 404 as well as other nodes that form the grid. These nodes are referred to as a replica serving host group, which are nodes listening for replica service requests. The information located within a request for a logical unit includes a descriptor for a set of files. Replica services associates a set of files with a descriptor. For example, a logical unit name “FOO ” may be associated with files. The requester will request the logical unit using this name. In response, the responding node from which the files are requested will send all the files associated with this logical unit name.

Although these examples illustrate the use of a multicast IP address, other mechanisms may be employed for allowing nodes in a grid to respond to requests for a logical unit. For example, a list of IP addresses may be specified in which a requester of a logical unit sends the request to every host in the replica serving host group identified in the list. A host may be added to the list as a side effect of receiving a logical unit. In response to this request, both node 404 and 408 will return a response to node 410. Node 410 may determine which node from which the logical unit will be obtained.

Different types of metrics, such as connection metrics may be used to select a node from the responding nodes. For example, a hop count, packet loss, location, and/or ping time may be used to identify or select a node. The selection is typically made in a fashion which allows for the fastest retrieval of the logical unit according to the present invention. These different metrics may be determined through various known tests. After a node is selected, node 410 then contacts the selected node and retrieves the logical unit from that node. In this manner, the mechanism of the present invention allows for an efficient method for distributing logical units, geographically disbursed through a network data processing system. This mechanism allows for a neighboring node, which may not be a replica server, to serve or distribute a requested logical unit. This type of distribution is often more efficient than having the logical unit being distributed by a replica server that is located in a remote geographical location.

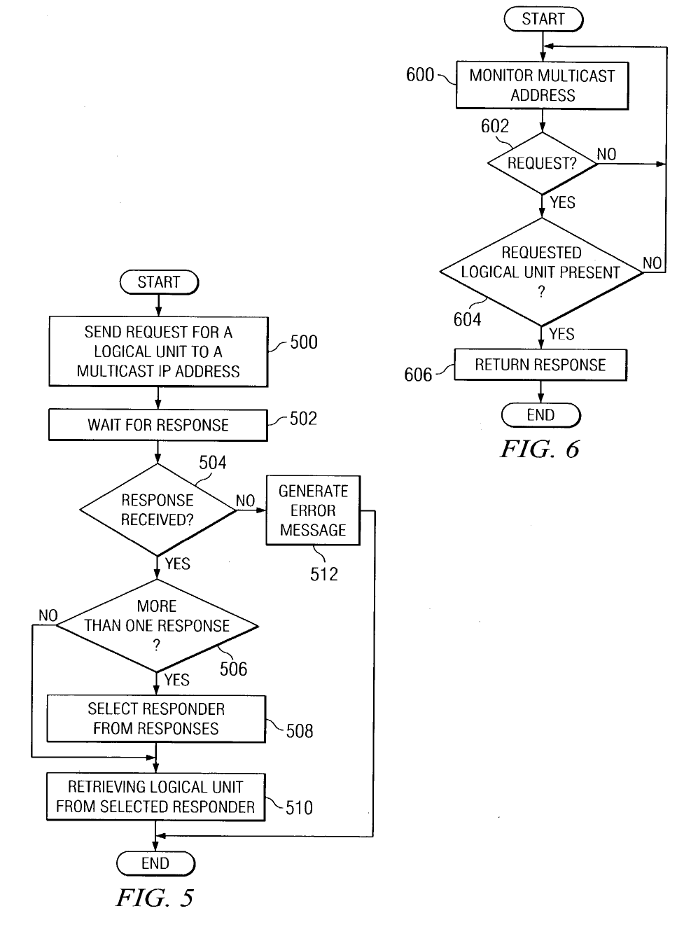

Turning next to FIG. 5, a flowchart of a process for requesting a logical unit is depicted in accordance with a preferred embodiment of the present invention. The process illustrated in FIG. 5 may be implemented in a node, such as node 410 in FIG. 4. The process begins by sending a request for a logical unit to a multicast IP address (step 500). The process then waits for a period of time to receive responses (step 502). A determination is made as to whether at least one response is received (step 504). Usually at least one response is expected from a replica server. Additional responses may be received if other nodes in the grid contain the requested logical unit.

If at least one response is received, a determination is made as to whether more than one response is present (step 506). If more than one response is present, a responder is selected from the responses (step 508). A particular responder is selected based on connection metrics. These metrics may include, for example, hop count, ping time, and/or packet loss. The logical unit is then retrieved from the selected responder (step 510), with the process terminating thereafter.

With reference again to step 506, if only one response is present, the process proceeds to step 510 with the responder of that response being the selected responder. Turning back to step 504, if a response is not received and an error message is generated (step 512), with the process terminating thereafter.

Turning now to FIG. 6, a flowchart of a process for responding to a request for a logical unit is depicted in accordance with a preferred embodiment of the present invention. The process illustrated in FIG. 6 may be implemented in any node in a grid, such as node 404 or 410 in FIG. 4.

The process begins by monitoring a multicast address for a request (step 600). A determination is made as to whether a request is received (step 602). If a request is not received, the process continues to return to step 600. Otherwise, a determination is made as to whether the requested logical unit in the request is present on the node (step 604). If the logical unit is present, a response is returned to requester (step 606) with the process terminating thereafter.

With reference again to step 604, if the requested logical unit is absent on the node, the process returns to step 600 as described above. This process may be implemented in any node, including a replica server.

Thus, The present invention provides a method, apparatus, and computer instructions for distributing logical units in a network data processing system. A mechanism of the present invention allows all nodes to monitor for requests for a particular logical unit. Any node containing the logical unit responds to the requestor. The requestor may then select a node from which the logical unit is to be retrieved. This selection is generally made based on identifying a node from which the logical unit may be most quickly obtained.

In this manner, a more efficient distribution of logical units may be made because a logical unit may be obtained from a neighboring node which is close by geographically rather than requiring the logical unit to be obtained from a replica server that is located in a remote geographic location. Further, this mechanism reduces the amount of traffic and reduces a possibility of a bottle neck at the replica server.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the illustrated examples are shown with respect to logical units. A mechanism of the present invention may be applied to other groupings of data, other than logical units. For example, the present invention may be applied to a single file or portions of a file depending on the particular implementation. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for obtaining a logical unit, the method comprising:
sending a request for the logical unit;
receiving responses to the request for the logical unit from a number of responders;
identifying a responder from the set of responders to form a selected responder, wherein the selected responder is identified based on at least one connection metric between the data processing system and the set of responders; and
retrieving the logical unit from the selected responder.

2. The method of claim 1, wherein the at least one connection metric includes at least one of a hop count, packet loss, location, and ping time.

3. The method of claim 1, wherein the set of responders includes a replica server.

4. The method of claim 1, wherein the request is sent to a multicast address.

5. The method of claim 1, wherein the set of responders is a number of nodes in a grid.

6. A network data processing system comprising:
a network; and
a plurality of nodes, wherein a first node within the plurality of nodes send a request for the logical unit onto the network; receives responses to the request for the logical unit from a set of nodes in the plurality of nodes; identify a responder from the set of nodes to form a selected nodes, wherein the selected nodes is identified based on at least one connection metric between the data processing system and the set of nodes; and retrieve the logical unit from the selected nodes.

7. The method of claim 6, wherein the network data processing system is a grid replica optimized wide area network.

8. A data processing system for obtaining a logical unit, the data processing system comprising:
sending means for sending a request for the logical unit;
receiving means for receiving responses to the request for the logical unit from a number of responders;
identifying means for identifying a responder from the set of responders to form a selected responder, wherein the selected responder is identified based on at least one connection metric between the data processing system and the set of responders; and
retrieving means for retrieving the logical unit from the selected responder.

9. The data processing system of claim 7, wherein the at least one connection metric includes at least one of a hop count, packet loss, location, and ping time.

10. The data processing system of claim 7, wherein the set of responders includes a replica server.

11. The data processing system of claim 7, wherein the request is sent to a multicast address.

12. The data processing system of claim 7, wherein the set of responders is a number of nodes in a grid.

13. A data processing system for obtaining a logical unit, the data processing system comprising:
a bus system;
a memory connected to the bus system, wherein the memory includes a set of instructions;
a communications adapter connected to the bus system; and
a processor connected to the bus system, wherein the processor executes the set of instructions to send a request over the communications adapter for the logical unit; receive, through the communications adapter, responses to the request for the logical unit from a number of responders; identify a responder from the set of responders to form a selected responder, wherein the selected responder is identified based on at least one connection metric between the data processing system and the set of responders; and retrieve the logical unit from the selected responder.

14. A computer program product in a computer readable medium for obtaining a logical unit, the computer program product comprising:
first instructions for sending a request for the logical unit;
second instructions for receiving responses to the request for the logical unit from a number of responders;
third instructions for identifying a responder from the set of responders to form a selected responder, wherein the selected responder is identified based on at least one connection metric between the data processing system and the set of responders; and
fourth instructions for retrieving the logical unit from the selected responder.

15. The method of claim 14, wherein the at least one connection metric includes at least one of a hop count, packet loss, location, and ping time.

16. The method of claim 14, wherein the set of responders includes a replica server.

17. The method of claim 14, wherein the request is sent to a multicast address.

18. The method of claim 1, wherein the set of responders is a number of nodes in a grid.
